(19) United States
(12) Patent Application Publication
(10) Pub. No.: US 2017/0126273 A1
(43) Pub. Date: May 4, 2017

(54) LOCATION MEASURING METHOD AND SYSTEM FOR ACCEPTABLE A PLURALITY OF UWB TAGS

(71) Applicant: INDUSTRIAL BANK OF KOREA, Seoul (KR)

(72) Inventors: Pilsoon SHIN, Busan (KR); Jongman KWON, Gwangju-si (KR)

(21) Appl. No.: 14/926,510

(22) Filed: Oct. 29, 2015

(51) Int. Cl. H04B 1/7075; H04J 13/16

(52) U.S. Cl. CPC H04B 1/7075; H04J 13/16; H04B 2201/7073

(57) ABSTRACT

The present invention relates to a location measuring method performed among an access point and a plurality of UWB tags and a location measuring system therefor. When a location is measured according to a relation between the access point and the UWB tag, collisions and interference occurring between signals in a wireless space may be avoided so that an efficient RTLS is implemented.

### BACKGROUND

1. Field of the Invention

The present invention relates to a location measuring method performed between an access point and a plurality of UWB tags and a location measuring system therefor.

2. Discussion of Related Art

In general, for location identifying or location measuring systems, there are methods using a Global Positioning System (GPS), an inertial navigation system (INS), long range aid to navigation (LORAN), a radio frequency identification/ubiquitous sensor network (RFID/USN), a wireless communication network or the like. Among these, “wireless location measuring technology,” which is a method using the wireless communication network, utilizes CDMA, OFDM, WLAN, infrared rays, ultrasonic waves, Bluetooth, RFID, UWB or the like in real time. Cell-ID, ToA, TDoA, AoA, or fingerprint techniques are used in order to accurately measure a location of a terminal, and technology development of wireless location measuring technology has been actively progressing in addition to technology concentration of the Internet of Things (IoT).

In the wireless location measuring technology, particularly, a location measuring method based on UWB is short-distance high-speed data transmission technology that is based on an ultra-wideband of IEEE 802.15.3a and is able to transmit multimedia data at low power through a wide bandwidth of 500 MHz or more. Comparing technologies of the related art based on WiFi or Bluetooth signals, there are advantages in that it is possible to accurately measure a distance at a high speed, and perform implementation at a low cost with reduced power consumption.

In such a wireless location measuring method based on UWB, a two-way ranging (TWR) method in which a round trip time (RTT) between an access point and a UWB tag is calculated and the calculated RTT is converted into a distance, a time difference of arrival (TDoA) method in which a time of arrival of a signal from an access point whose time is synchronized to a tag is measured simultaneously to calculate a distance or the like is performed. As a result, it can be seen that a signal exchange time between the access point and the tag is a basis of the wireless location measuring method based on UWB.

However, when the number of tags configured to transmit and receive a signal increases in a limited space, there are problems in that a possibility of a collision increases in a wireless space (air) in which communication is performed using limited resources, and interference between signals may occur. In view of such problems, the inventors of this application propose the present invention in order to prevent collisions from occurring in the wireless space, avoid interference between the access point and a plurality of tags, and ultimately perform location tracking more quickly.

A UWB tag location estimating system and a method thereof are described in Korea Patent No. 1243301. The method and system include transmitting a search signal to a plurality of tags, receiving a response signal in response to the search signal, extracting tag information corresponding to each of the plurality of tags from the response signal, and estimating distance information through communication between tags according to whether the response signal is transmitted. However, this invention has a limitation that it is unable to address the above-described problems even if it is possible to estimate a location of the UWB tag in an environment having no access point.

A system and method in which synchronization of a base station is easily performed in a wireless communication environment are described in U.S. Pat. No. 8,774,084. The method including receiving a first signal including first synchronization information with accuracy of a first level in a base station, synchronizing a clock of the base station with a first time accordingly, receiving a second signal including second synchronization information having a higher accuracy than the first level, and synchronizing the clock of the base station with a second time accordingly is disclosed. The system and method are advantageous in that a re-use channel may be shared among several base stations when the base station is synchronized, but it is difficult to directly apply the system and method to a communication network based on UWB and address the above-described problems.

### SUMMARY OF THE INVENTION

The present invention is provided to avoid collisions and interference that may occur between wireless signals when a location is measured according to a relation between an access point and a UWB tag and a signal is transmitted and received to and from a plurality of UWB tags at very frequent intervals.

Further, according to a location measuring method for accommodable a plurality of UWB tags and a system therefor of the present invention, an ultimate object is to implement signal tracking more rapidly and accurately than a real time location measuring system of the related art.

As an embodiment of the present invention, there is provided a location measuring method for accommodable a plurality of UWB (ultra-wideband) tags. The method is distinguished as an aspect performed by an access point (AP), and an aspect performed by a plurality of UWB tags.

First, the first method, performed by the AP, in order to accommodate the plurality of UWB tags includes transmitting a clock synchronization packet (CSP); and receiving a response packet transmitted based on a period according to the CSP and a unique value of the UWB tag from each of the plurality of UWB tags. The first method may further include allocating the unique value to each of the plurality of UWB tags, before the transmitting of the CSP.

More specifically, the receiving of the response packet may include receiving the response packet transmitted within a blink term (BT) from a time that is computed by an i-th tag among the plurality of UWB tags according to M_{I}+(BT×(i−1)), and the BT may be calculated according to [T_{CSP}−(M_{I}+M_{L})/the number of UWB tags], M_{I} may denote an initial margin time, and M_{L} may denote a last margin time.

Next, the second method, performed by the plurality of UWB tags, in order to accommodate the plurality of UWB tags includes: allocating a unique value to each of the plurality of UWB tags; receiving a clock synchronization packet (CSP); and transmitting a response packet based on a period (T_{CSP}) according to the received CSP and the unique value of the tag.

Specifically, in the allocating of the unique value, the unique value may be designated in advance by an access point (AP) or the plurality of UWB tags may designate the unique value to each other.

In addition, the transmitting of the response packet may further include: calculating a blink term (BT) according to [T_{CSP}−(M_{I}+M_{L})/the number of UWB tags], and computing, by an i-th tag of the plurality of UWB tags, a transmission start time of a response packet of the i-th tag according to M_{I}+(BT×(i−1)); waiting until the computed transmission start time; and transmitting, by the i-th tag, the response packet within the BT from the computed transmission start time, and M_{I} denotes an initial margin time, and M_{L} denotes a last margin time.

Also, the second method may further include: determining whether the T_{CSP} is expired; when the T_{CSP} is expired, terminating a session of the received CSP and waiting for reception of a following CSP; and when the T_{CSP} is not expired, continuously waiting until the computed time at which the response packet is transmitted, and transmitting, by the i-th tag, the response packet within the BT from the computed time at which the response packet is transmitted.

As another embodiment of the present invention, there is provided a location measuring system for accommodable a plurality of UWB tags. The system includes an access point configured to transmit a clock synchronization packet (CSP), and a plurality of UWB tags configured to receive the CSP, and transmit a response packet based on the CSP, a period (T_{CSP}) according to the CSP, and a unique value of the tag.

Here, the access point may allocate the unique value to the plurality of UWB tags before the CSP is transmitted, and a blink term (BT) calculated according to [T_{CSP}−(M_{I}+M_{L})/the number of UWB tags] is transmitted to the plurality of UWB tags.

Meanwhile, the plurality of UWB tags may allocate the unique value to each other before the CSP is received, and a blink term (BT) may be calculated according to [T_{CSP}−(M_{I}+M_{L})/the number of UWB tags] and designated.

An i-th tag of the plurality of UWB tags may compute a transmission start time of the response packet of the i-th tag according to M_{I}+(BT×(i−1)), wait until the computed transmission start time, and transmit the response packet within the BT from the computed transmission start time, and M_{I} may denote an initial margin time, and M_{L} may denote a last margin time. No response packet may be transmitted by the plurality of UWB tags for the M_{I} and the M_{L}.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a concept of a configuration of a location measuring system according to the present invention;

FIG. 2 is a time diagram illustrating signal transmission and reception among an access point and a plurality of UWB tags in a location measuring method and system according to the present invention;

FIG. 3 is a flowchart illustrating a first method performed by an access point in a location measuring method according to the present invention;

FIG. 4 is a flowchart illustrating a second method performed by a UWB tag in a location measuring method according to the present invention; and

FIG. 5 is a flowchart comprehensively illustrating a location measuring method according to the present invention.

### DETAILED DESCRIPTION OF EXEMPLARY EMBODIMENTS

Hereinafter, various embodiments of a location measuring method and location measuring system for accommodable a plurality of UWB tags according to the present invention will be described with reference to the accompanying drawings.

It will be understood that the terms “comprise,” and “include,” when used herein, specify the presence of stated components, features, and operations, but do not preclude the presence of one or more other components, features, operations and equivalents thereof. Also, the singular forms “a” and “an” are intended to include the plural forms as well, unless the context clearly indicates otherwise. That is, components stated as the term “include” herein refer to the presence or addition of one or more other components.

The term “access point” herein refers to a fixed station that is used to communicate with access terminals and may be called a node, an eNodeB, an HeNB or other terms. It will be understood that the access point refers to various devices having a function for communicating with terminals regardless of the terms “random access point,” “relay access point,” and “router access point” referred to in the market.

In addition, technical terms used throughout this specification are selected from among general technical terms that are currently and widely used. In certain cases, some terms may be arbitrarily selected by the applicants. In such cases, meanings thereof should be interpreted in consideration of a description of embodiments and meanings as used in context, rather than simply the terms themselves.

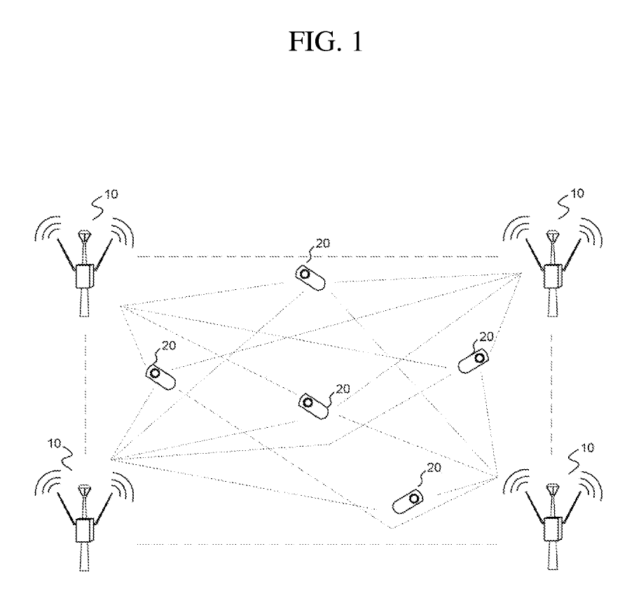

First, FIG. 1, which is a diagram illustrating a concept of a configuration of a location measuring system according to the present invention, is referred to. It can be understood that, in an illustrated space, four access points 10 are respectively disposed at corners, and a plurality of UWB tags 20 are disposed in a space in which the access point 10 is disposed. However, it should be noted that the four access points 10 and the five UWB tags 20 are illustrated in the example of FIG. 1 for convenience of illustration, but the number of components, and particularly, the number of tags 20, is not limited, and the components may be included in the location measuring system according to the present invention.

The access point 10 is selected as a general term, and may be variously called a node, an eNodeB, an HeNB, a random access point, a relay access point, a router access point or the like described above, and collectively called a node capable of communicating with the tag 20 using a UWB communication method according to IEEE 802.15.3a.

The access point 10 may transmit a clock synchronization packet (CSP) to each of the UWB tags 20, and receive a response packet from each of the UWB tags 20.

Also, each of the UWB tags 20 receives a unique value, receives the CSP from the access point 10, and transmits a response packet based on a period (T_{CSP}) according to the CSP in response to the received CSP and a unique value of the tag.

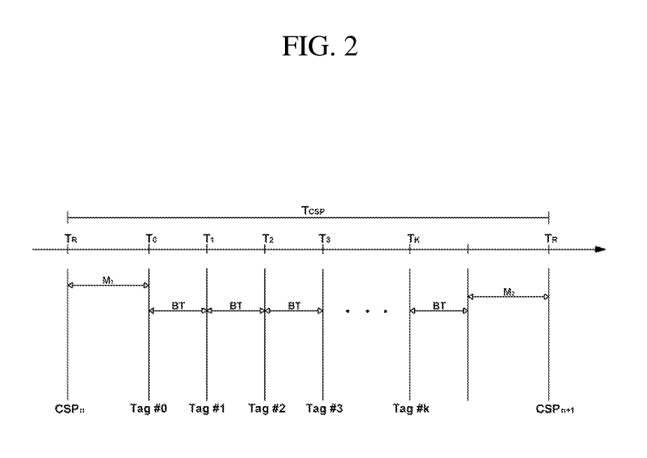

A time diagram of FIG. 2 is referred to describe a detailed signal flow among the access point 10 and the plurality of UWB tags 20.

As illustrated in FIG. 2, from left to right with respect to a time axis, T_{R}, T₁, T₂, T₃, . . . , T_{K}, T_{K+1}, and T_{R} are displayed. The preceding T_{R} represents a reference time at which a preceding clock synchronization packet (CSPₙ) from the access point is received by each of the UWB tags. The succeeding T_{R} represents a reference time at which a following clock synchronization packet (CSPₙ₊₁) is received from the access point. FIG. 2 will be described with a focus on a flow of signals transmitted and received among the access point and the plurality of UWB tags at a time at which an n-th clock synchronization packet (CSPₙ) is received.

Before the n-th clock synchronization packet (CSPₙ) is received, each of the UWB tags has a unique value. The unique value of the tag may be designated by a specific access point that is designated as a master among APs, or the unique value of the tag may be designated by a random AP rather than the AP that is separately designated as a master. Further, the unique value may be allocated autonomously according to a signal exchange method of each of the UWB tags.

For example, when 30 UWB tags are operated in a space of the location measuring system according to the present invention, each of the tags may have a value of 0 to 29, or a value of 1 to 30. According to this range, the unique value may be designated for each of the UWB tags in a non-overlapping manner.

Also, when the clock synchronization packet is received at a time of T_{R} of CSPₙ, in a time zone (that is, BT×k) excluding an initial margin term M₁ and a last margin term M₂ within the period (T_{CSP}) according to the clock synchronization packet, k UWB tags transmit a response packet (signal) to the access point during a blink term (BT) that is uniquely allocated to each of the UWB tag.

As exemplified above, it is assumed that 30 UWB tags are operated in the space of the location measuring system according to the present invention, the tags receive a unique value of 0 to 29, a total period according to the clock synchronization packet is 100 ms, and the initial margin term M_{I} is 10 ms.

In the above example, when it is additionally assumed that the last margin term M₂ is also 10 ms, the same as the initial margin term M₁, an arithmetically calculated BT becomes

$$\frac{100 ms \text{-} ( 10 ms \times 2 )}{30} = 2.666 … .$$

In this case, exemplary BT terms of UWB tags numbered from #0 to #4 are as follows.

TABLE 1

| | BT start time | BT end time |
|---|---|---|
| UWB #0 | 10 ms | 12.6666 . . . ms |
| UWB #1 | 12.6666 . . . ms | 15.3333 . . . ms |
| UWB #2 | 15.3333 . . . ms | 17.9999 . . . ms |
| UWB #3 | 17.9999 . . . ms | 20.6666 . . . ms |
| UWB #4 | 20.6666 . . . ms | 23.3333 . . . ms |

Such BT computation is changed to an integer according to a Gaussian symbol formula, and thus each BT may be calculated as 2 ms. That is, in the location measuring system according to the present invention, the BT may be obtained by the following formula.

BT=[T_{CSP}−(M_{I}+M_{L})/the number of UWB tags]

Here, M_{I} and M_{L} denote an initial margin time and a last margin time of a single clock synchronization packet, respectively, and refer to a guard interval in which none of the plurality of UWB tags transmits the response packet during the these times.

When each BT is determined as 2 ms according to Gaussian computation as the above formula, an i-th tag among the plurality of UWB tags computes a start time at which the tag transmits the response packet according to M_{I}+(BT×(i−1)) and the i-th tag transmits the response packet within the BT from the computed transmission start time.

Therefore, a first UWB tag (in the above example, UWB #0 although an i value is defined as 1) waits until 10 ms and transmits a first response packet between 10 ms and 12 ms. A second UWB tag (in the above example, UWB #1) waits until 12 ms and transmits a second response packet between 12 ms and 14 ms. According to the same method, a 29-th UWB tag (in the above example, UWB #28) waits until 66 ms and transmits a 29-th response packet between 66 ms and 68 ms, and finally, a 30-th UWB tag (in the above example, UWB #29) waits until 68 ms and transmits a 30-th response packet between 68 ms and 70 ms. Therefore, a last margin time M_{L} is derived as a period of 30 ms between the remaining time 70 ms and 100 ms, and may be regulated to 30 ms from the last margin time M_{L} 10 ms that is initially set.

According to such a method, since the plurality of UWB tags of the location measuring system transmit a response packet at different terms, when the number of response packets transmitted by each of the UWB tags increases as the number of UWB tags increases, it is possible to prevent collisions and interference between packets transmitted from individual tags to the access point in a wireless area.

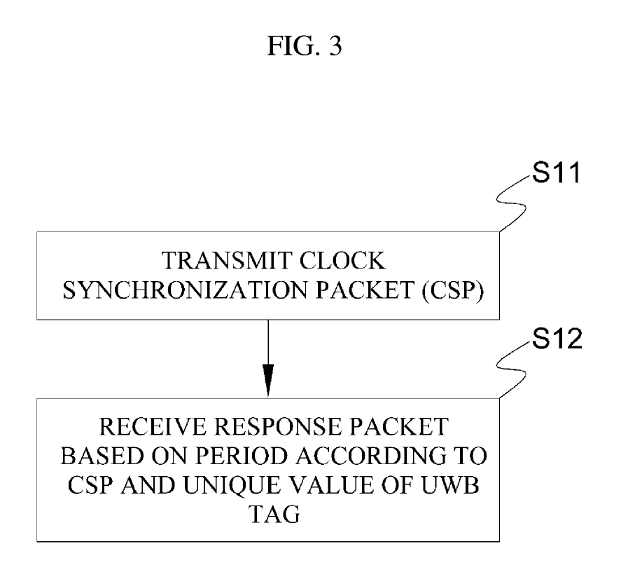

FIG. 3 is a flowchart illustrating a method performed by an access point in a location measuring method according to the present invention.

First, the access point transmits a clock synchronization packet (CSP) via a UWB communication network (operation S11). The clock synchronization packet is used to synchronize a plurality of UWB tags of the location measuring system in a time domain, and may be referred to as various terms such as a reference packet, a reference signal, a clock signal, or a synchronization reference signal as long as it is used to perform a synchronization function among UWB tags via the UWB communication network, regardless of its format.

Next, the access point receives a response packet based on a period according to the CSP from individual UWB tags via the UWB communication network and the unique value of each of the UWB tags (operation S12).

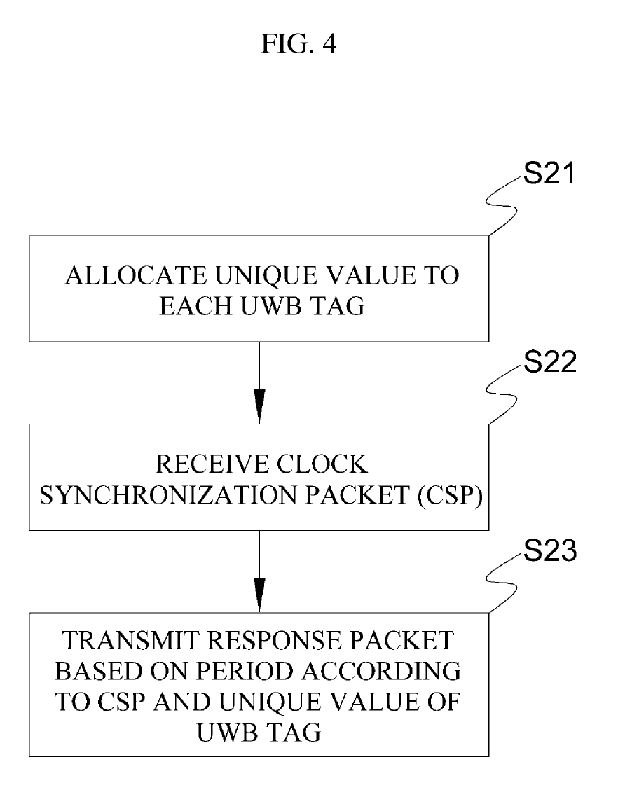

In correspondence with FIG. 3 that is illustrated based on the access point, in FIG. 4 that is illustrated based on the UWB tag, S11 and S12 of FIG. 3 correspond to S22 and S23 of FIG. 4, respectively.

First, the unique value is allocated for each of the plurality of UWB tags (operation S21). Allocation of the unique value to each of the UWB tags may be performed by the access point or the unique value may be allocated autonomously according to a random processing method in which the UWB tags are assigned a number in a non-overlapping manner.

Also, in addition to allocation of the unique value, a blink term (BT) value calculated by [T_{CSP}−(M_{I}+M_{L})/the number of UWB tags] may be received from the access point, or the blink term (BT) value may be calculated according to the unique value and the period of the clock synchronization packet and designated to each of the UWB tags.

Then, all of the UWB tags each receive a clock synchronization packet (CSP) from the access point (operation S22), and a response packet is transmitted from each of the UWB tags to the access point based on a period according to the CSP and the unique value of the UWB tag (operation S23).

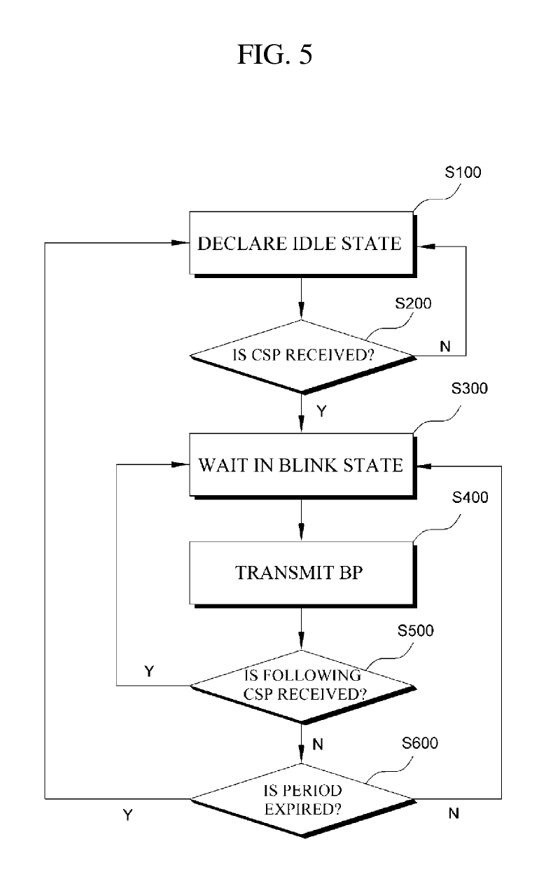

FIG. 5 is a flowchart comprehensively illustrating a location measuring method according to the present invention and that is illustrated based on each of the UWB tags. Examples separately illustrated in FIGS. 3 and 4 may be integrally described through descriptions of FIG. 5.

First, before synchronization necessary for measuring a location, an IDLE state is declared (operation S100), and thus start of transmission and reception of a clock synchronization packet among an access point and UWB tags of a location measuring system may be notified of.

Then, it is determined whether the clock synchronization packet (CSP) is received (operation S200). When it is determined that the packet is received, the computed BT value and each individual tag wait in a blink state until its own response packet start time (operation S300). The response packet is transmitted at its own response packet start time (operation S400; the response packet is represented as a blink packet (BP) in FIG. 5).

Here, in a detailed implementation example of operations S200 to S400, content described above in FIG. 2 may be similarly applied.

Also, it is determined whether a following clock synchronization packet (CSP) is received (operation S500). When it is determined that the following CSP is received (Y), waiting is performed in a blink state until the above-computed packet start time. In some cases, when the number of tags is changed, its own response packet start time is changed and thus the response packet start time may be updated in consideration of the change.

When no following CSP is received in operation S500, it is determined whether the period according to the CSP received in the above operation S200 is expired (operation S600). When the period is expired (Y), an IDLE state is declared again, and the tag remains in a state in which reception of a new clock synchronization packet is awaited. On the other hand, when the period according to the CSP is not expired, the tag remains in a blink state and continuously waits until a time at which its own response packet is transmitted.

According to a location measuring method and location measuring system for accommodable a plurality of UWB tags of the present invention, even if the number of signals to be transmitted and received increases as the number of UWB tags significantly increases in a location measuring environment including an access point and a plurality of UWB tags, it is possible to avoid collisions and interference between signals to be transmitted and received among the tags.

Ultimately, according to a location measuring method and system of the present invention, it is possible to implement an efficient RTLS such that more rapid and accurate location tracking than a real time location measuring method and system of the related art is possible.

While the embodiments of the present invention have been described above in detail, it should be understood by those skilled in the art that the scope of the present invention is not limited thereto but includes various alternations, changes, modifications, and equivalents derived from the basic concept of the present invention defined in claims to be described.

### REFERENCE NUMERALS

10: access point
20: UWB tag

1. A location measuring method for accommodable a plurality of ultra-wideband (UWB) tags that is performed by an AP, the method comprising:
transmitting a clock synchronization packet (CSP);
receiving a response packet transmitted based on a period according to the CSP and a unique value of the UWB tag from each of the plurality of UWB tags; and
allocating the unique value to each of the plurality of UWB tags, before the transmitting of the CSP,
wherein the receiving of the response packet includes receiving the response packet transmitted within a blink term (BT) from a time that is computed by an i-th tag among the plurality of UWB tags according to M_{I}+(BT×(i−1)),
wherein the BT is calculated according to [T_{CSP}−(M_{I}+M_{L})/the number of UWB tags], and
wherein M_{I} denotes an initial margin time, and M_{L} denotes a last margin time.

2-3. (canceled)

4. A location measuring method for accommodable a plurality of UWB tags performed by the plurality of UWB tags, the method comprising:
allocating a unique value to each of the plurality of UWB tags;
receiving a clock synchronization packet (CSP); and
transmitting a response packet based on a period (T_{CSP}) according to the received CSP and the unique value of the tag,
wherein, in the allocating of the unique value, the unique value is designated in advance by an access point (AP),
wherein the transmitting of the response packet further includes:
calculating a blink term (BT) according to [T_{CSP}−(M_{I}+M_{L})/the number of UWB tags], and computing, by an i-th tag of the plurality of UWB tags, a transmission start time of a response packet of the i-th tag according to M_{I}+(BT×(i−1));
waiting until the computed transmission start time; and
transmitting, by the i-th tag, the response packet within the BT from the computed transmission start time, and
wherein the M_{I} denotes an initial margin time, and M_{L} denotes a last margin time.

5. (canceled)

6. The location measuring method according to claim 4,
wherein, in the allocating of the unique value, the plurality of UWB tags designate the unique value to each other.

7-8. (canceled)

9. The location measuring method according to claim 4,
further comprising:
determining whether the T_{CSP} is expired;
when the T_{CSP} is expired, terminating a session of the received CSP and waiting for reception of a following CSP; and
when the T_{CSP} is not expired, continuously waiting until the computed time at which the response packet is transmitted, and transmitting, by the i-th tag, the response packet within the BT from the computed time at which the response packet is transmitted.

10. (canceled)

11. A location measuring system for accommodable a plurality of UWB tags, comprising:
an access point configured to transmit a clock synchronization packet (CSP); and
a plurality of UWB tags configured to receive the CSP and transmit a response packet based on a period (T_{CSP}) according to the CSP and a unique value of the tag,
wherein the access point allocates the unique value to the plurality of UWB tags before the CSP is transmitted, and
a blink term (BT) calculated according to [T_{CSP}−(M_{I}+M_{L})/the number of UWB tags] is transmitted to the plurality of UWB tags,
wherein an i-th tag of the plurality of UWB tags computes a transmission start time of the response packet of the i-th tag according to M_{I}+(BT×(i−1)), waits until the computed transmission start time, and transmits the response packet within the BT from the computed transmission start time, and M_{I} denotes an initial margin time, and
wherein M_{L} denotes a last margin time.

12. (canceled)

13. The location measuring system according to claim 11,
wherein the plurality of UWB tags allocate the unique value to each other before the CSP is received.

14-15. (canceled)

16. The location measuring system according to claim 11,
wherein no response packet is transmitted by the plurality of UWB tags for the M_{I} and the M_{L}.

17. (canceled)
